(19) United States
(12) Patent Application Publication
(10) Pub. No.: US 2004/0221680 A1
(43) Pub. Date: Nov. 11, 2004

(54) Footrest with heel stirrup assembly for motorcycles

(76) Inventors: William DeWayne Utzman, The Colony, TX (US); Bobby Wayne Lakin, Richardson, TX (US); Stephen Bradley Lindsey, Murphy, TX (US)

Correspondence Address: William DeWayne Utzman, 5236 Pruitt Dr., The Colony, TX, 75056, US

(21) Appl. No.: 10/732,564

(22) Filed: Dec. 10, 2003

Related U.S. Application Data
(60) Provisional application No. 60/432,720, filed on Dec. 12, 2002.

(51) Int. Cl. G05G 1/18

(52) U.S. Cl. 74/564

(57) ABSTRACT

An improved footrest for motorcycles featuring a recessed planar area to accept and support the heel of rider footwear. A raised lip bordering the recessed area serves to retain secure placement of heel within said recess. The footrest body is counter bored to accept existing mount hardware appropriate to application and secured by a bolt passing through the counter bore into mount hardware. Angular orientation is secured by a plurality of set screws in the footrest body positioned to seat on mount hardware.

### REFERENCES CITED

U.S. Patent Documents

| | | |
|---|---|---|
| 1,261,442 | 4/1918 | Rigby |
| 4,174,852 | 11/1979 | Panzica et al. |
| 6,422,653 | 7/2002 | Szczepanski et al. |
| 5,842,307 | 1/1996 | Lin |
| Des. 395,024 | 6/1998 | Baratti |

### BACKGROUND OF INVENTION

Motorcycles, in particular, have been fit with a round or oval shaped footpegs or an elongate flat floorboards for foot support while riding, although adequate to their purpose and design for short distance riding, they are lacking in respect to distance and extended periods of travel. While floorboards do provide full boot support, they will not fit many motorcycle types and styles of manufacture and do not provide for secure placement of boot without need for continued adjustment of boot position. The round or oval footpeg provides for support contact only in the arch area of the boot with no provision for aiding a secure boot placement. As is evident, both types of boot supports allow inherent mechanical vibrations and road surface shocks to displace the boot position causing the need for constant repositioning and/or. the maintaining of muscular pressure to hold boot in position.

The current invention addresses these insufficiencies by providing footrests as a pair, designed to fit most types and styles of motorcycles in manufacture today with little or no modification. The recessed planar area in combination with the surrounding lip provide support for the boot and containment of the boot heel providing secure and consistent retainage of boot placement. This invention virtually eliminates the need for boot repositioning due to vibration and roadway shock. In addition, this invention increases rider comfort and enjoyment by reducing the leg fatigue associated with the aforementioned situations. In these respects, the current invention substantially departs from concepts and designs of prior art and provides a footrest assembly primarily developed to improve the ride experience in longer distance motorcycle travel. In addition, the current invention contributes to highway safety by relieving stress and fatigue as described above.

### SUMMARY OF INVENTION

The objective of this invention is to provide an improved footrest assembly to provide a more secure foot placement lessening the need to continually adjust foot position. As a result, this footrest greatly enhances rider comfort and lessens fatigue from riding long distances. This is accomplished thru the design of the perimeter lip surrounding the recessed planar area, structured in a manner to catch the heel of the rider's boot in 3 to 4 areas thereby holding the foot securely in position, eliminating the situation of the foot vibrating or bouncing out of position, as is a common happening with common footrest designs.

Attachment of current invention utilizes common prior art hardware as illustrated in drawings and descriptions thereof, requiring no in-depth structural modifications and continues to allow angular rotation position adjustment to meet individual rider comfort requirements.

### Description/Specification

footrests as a pair (2);

each with a recessed planar surface to accept and support the heel of the rider's boot;

each with a lip surrounding the recessed planar surrface structured to contact the boot heel at 3 to 4 points;

each attaches readily to prior art footpeg hardware; and

each allows angular rotation adjustment (relative to the ground) for enhanced rider comfort and fit.

### BRIEF DESCRIPTION OF DRAWINGS

FIG. 1

Top plan view of current invention for left-hand side, the right-hand side being a mirror image thereof.

Dashed line represents an internal void (13) for acceptance of prior art hardware and allowance for securing current invention to said hardware by means of affixing the bolt insertion thru hole (15) (see FIG. 4 for fitment diagram).

(11) being the recessed planar area leaving (10) as the lip surrounding the recessed plan, (10 and 11) together form the heel rest and stirrup. (14) completes the foot rest serving as arch support and facility for attachment to prior art hardware.

FIG. 2

Side view of current invention, (17) being a set screw for securing angular rotation positioning.

FIG. 3

Cross sectional view reflecting recessed plane (11) relative to side of footrest and the surrounding lip (10).

FIG. 4

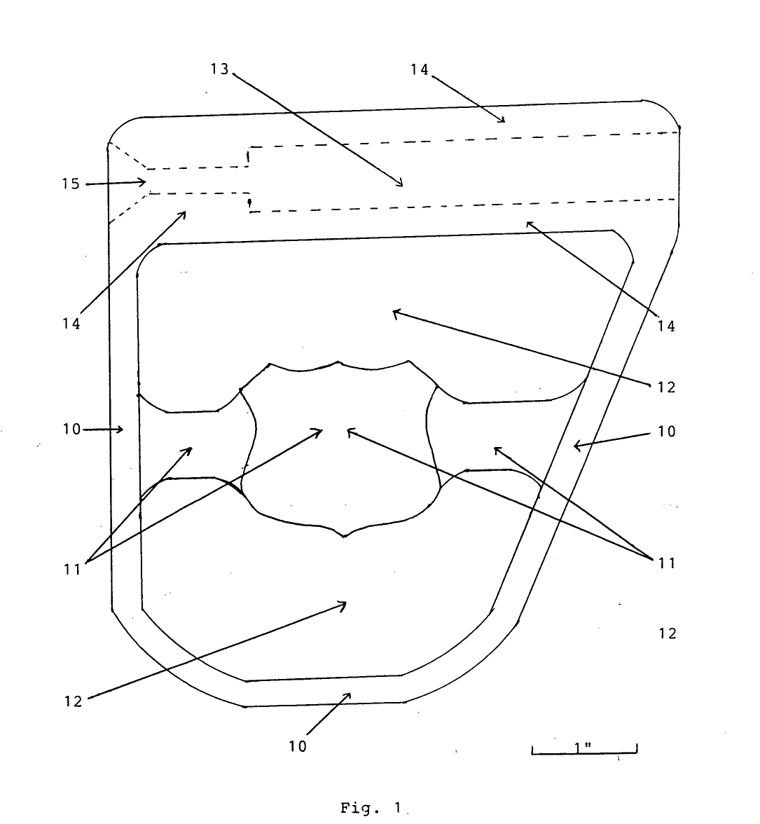

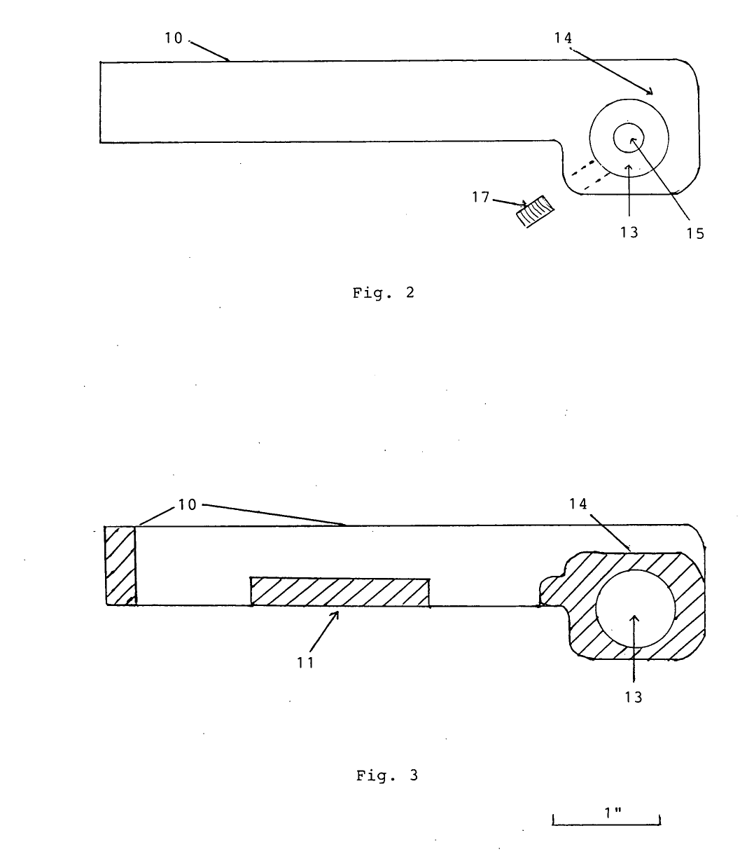

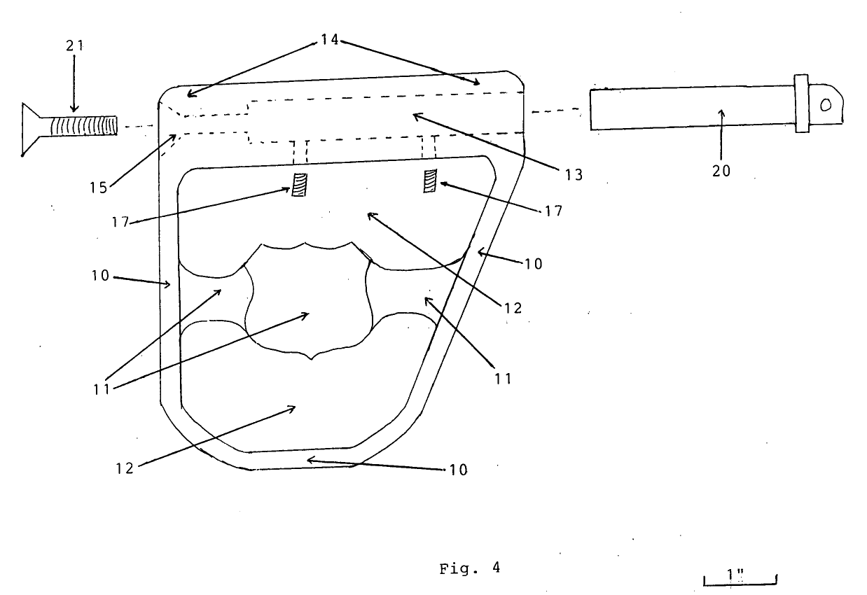

Diagram for affixing current invention to prior art hardware via thru-bolt (21) insertion thru current invention into prior art hardware (20) with angular orientation secured by set screws (17) thereby completing the installation.

### DESCRIPTION OF PREFERRED EMBODIMENT

As those skilled in the art are aware, most motorcycles are equipped with footpegs on either side of the motorcycle to provide foot support for the rider and passenger.

This discussion focuses on the rider footpegs although the application is equally appropriate for passenger footpegs.

The footpeg assembly comprises a bracket designed to receive and fit a footpeg shaft (FIG. 4, 20) a bolt which passed through the bracket and mounting ear of said shaft thereby affixes the footpeg assembly to the motorcycle and providing a vertical motion pivot point for the assembly.

The current invention utilizes the existing bracket coupled with the appropriate footpeg shaft (FIG. 4, 21) to attach the footrest assembly to the motorcycle. The footpeg shaft is a prior art, currently available item with selection to provide proper fit to most motorcycles of current manufacture.

Once the footpeg shaft is appropriately matched and attached within the aforementioned bracket, the current invention may be installed by sliding the void (FIG. 4, 13) located within the arch support body (FIG. 4, 14) over the footpeg shaft. Secure attachment of current invention is supported by the through bolt (FIG. 4, 21) being passed through bolt hole (FIG. 4, 15) into threaded end of footpeg shaft and appropriately tightened.

Angular (to the ground) orientation is accomplished by manual rotation of current invention to position of rider preference and comfort. Orientation is locked in place by tightening the plurality of set screws (FIG. 4, 17) into the footpeg shaft. Thus completing the installation.

As is evident, this is a simple, straightforward installation of an improved, new footrest assembly as replacement for current footpegs in design and use today.

With respect to the prior discussion of the current invention, it is to be realized that those skilled in the art will recognize numerous changes and modifications are possible. Therefore, it is not desired to limit the invention to the exact construction, specification or design as shown and described and accordingly all suitable and applicable modification and equivalents are to be inclusive within the scope and nature of current invention.

We claim:

1. footrest as an assembly for motorcycles and the like comprising a mount design allowing for ready attachment to existing footpeg hardware.

2. the aforementioned mount design with a plurality of set screws allowing rotation of assembly to fit user/rider preference.

3. the said mount design utilizing a through bolt to securely affix footrest to mounting hardware.

4. the footrest of 1 with a recessed planar area to accept and support the heel of user/rider footwear (preferably a boot type of protective footwear).

5. the planar area of 4 bounded on the perimeter with a raised lip to secure placement of footwear heel within said planar area.
